(19) United States
(12) Patent Application Publication
(10) Pub. No.: US 2007/0186104 A1
(43) Pub. Date: Aug. 9, 2007

(54) Equipment authentication device

(75) Inventor: Ichiro Suzuki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/474,672

(22) Filed: Jun. 26, 2006

(30) Foreign Application Priority Data
Feb. 7, 2006 (JP) 2006-029664

(51) Int. Cl. H04L 9/00

(52) U.S. Cl. 713/168

(57) ABSTRACT

A web client device 20 is installed with an agent program 21 for requesting an authentication switch device 30 interposed between a Web server device 10 and the Web client device 20 to access the Web server device 10. The authentication switch device 30, when accepting the request from a function based on the agent program 21, acquires a MAC address from this function, and executes equipment authentication using the acquired MAC address. If the equipment authentication gets unsuccessful, the authentication switch device 30 acquires user information and password information of a user from the function, and executes the equipment authentication using these items of information. If the second equipment authentication gets successful, the authentication switch device 30 registers the previously-acquired MAC address and employs the MAC address for the equipment authentication from the second time onward. The present invention facilitates a registration operation while assuring that only the equipment authorized to establish a network connection is registered.

### BACKGROUND OF THE INVENTION

1. Field of the Invention

The present invention relates to an equipment authentication device for judging whether equipment making a request for a connection to a network can be authorized or not.

2. Related Background Art

As known widely, in a network administered by an organization such as an enterprise, equipment authentication is to be conducted in order to prevent leakage of information and an unauthorized connection by unauthorized means such as spoofing. The equipment authentication is a technique of authorizing the equipment (PC) to establish the network connection by requesting the equipment (PC) requesting the network connection to send unique information of the equipment (PC) and confirming that the unique information is coincident with pre-registered information. The following methods are methods of pre-registering the unique information of the equipment (PC).

A first method is that a user of the equipment (PC) displays and reads the unique information of the equipment by employing commands and GUI (Graphical User Interface) on the equipment, and notifies a network administrator of the readout information, and the network administrator manually registers the information in the equipment authentication device.

A second method is that after temporarily connecting the connection-authorized equipment to the network, a device for collecting pieces of unique information of the respective equipment connected to the network is connected to this network, and the network administrator manually registers the unique information collected by the collecting device in the equipment authentication device.

A third method is that the equipment authentication device incorporates a function of collecting the unique information of the respective equipment in a way that links up with the individual equipment connected to the network, and the equipment authentication device is made to collect the unique information of the respective equipment connected to the network for a fixed period of time as the unique information of the equipment authorized to establish the network connection (refer to Patent document 1).

[Patent document 1] Japanese Patent Application Laid-Open Publication No. 2004-343497

The first method described above, however, causes such problems that the user of the equipment and the network administrator are burdened with registering the unique information, and the registration operation is complicated. Further, the registration depends on the manual operation, wherein a mis-input might occur.

Moreover, the second method described above causes such a problem that the device for collecting the unique information of the respective equipment authorized to establish the network connection must be separately prepared, and a cost for introducing the device increases. Further, as in the first method, the registration depends on the manual operation, wherein the mis-input might occur.

Still further, according to the third method described above, there is no assurance that the equipment connected to the network within the fixed period of time is the equipment that should be authorized to connect with the network, and hence the equipment authentication device is to be registered with the unique information of the equipment that originally should not be authorized to connect with the network.

### SUMMARY OF THE INVENTION

It is an object of the present invention, which was devised in view of the problems inherent in the prior arts described above, to facilitate a registration operation while assuring that only equipment authorized to establish a network connection is registered.

According to a first mode of an equipment authentication device devised for solving the problems, an equipment authentication device comprises a first storage unit storing unique information of equipment with respect to some equipment in pieces of equipment authorized to establish a connection to a network, a second storage unit storing identification information and password information of a user of the equipment with respect to the respective pieces of equipment, a first authentication unit judging, when accepting a network connection request together with the unique information of the equipment from any one of pieces of the equipment via a communication device, whether or not the unique information is coincident with any one of pieces of unique information stored in the first storage unit; a switchover unit setting, when the first authentication unit judges that the unique information is coincident with the other piece of unique information, the equipment concerned in a network communication-enabled status, a second authentication unit acquiring, when the first authentication unit judges that the unique information is not coincident with the other piece of unique information, the identification information and the password information of the user from the equipment concerned, and judging whether or not a tuple of the identification information and the password information is coincident with a tuple of the identification information and the password information stored in the second storage unit, and a registration unit registering, when the second authentication unit judges that the tuples of the identification information and the password information are coincident with each other, the unique information of the equipment concerned in the first storage unit.

With this configuration, when the unique information from the equipment requesting the network connection, irrespective of whether the unique information of the equipment concerned is registered or not, the equipment is authenticated by use of this unique information. Then, when succeeding in the authentication, the equipment authentication is not conducted from that onward. When the authentication gets into a failure, however, the identification information and the password information of the user are acquired, and the authentication is further conducted by employing these items of information. When this authentication gets successful, it follows that the unique information of the equipment is registered, and, once this unique information is registered, the equipment is authenticated by only this unique information from that onward. Hence, according to the first mode, there is no necessity of being burdened with reading the unique information from the equipment and manually registering the unique information and of taking a means for separately preparing the device for collecting the unique information. Besides, the authentication is invariably conducted by use either of the tuple of the identification information and the password information of the user or the unique information, and therefore it never happens that the unique information of the equipment that should not be authorized to connect with the network is mistakenly registered.

According to a second mode of an equipment authentication device devised for solving the problems, an equipment authentication device comprises a third storage unit storing identification information and password information of user of equipment with respect to each piece of equipment authorized to establish a connection to a network, a fourth storage unit storing unique information of the equipment with respect to some pieces of equipment in the pieces of equipment, a third authentication unit judging, when accepting a network connection request together with identification information and password information of a user of the equipment and the unique information of the equipment from any one of pieces of the equipment via a communication device, whether or not a tuple of the identification information and the password information is coincident with a tuple of the identification information and the password information stored in the third storage unit, a status judging unit judging, when the third authentication unit judges that the tuples of the identification information and the password information are coincident with each other, whether an operation status is a registration required status in which the unique information of the equipment concerned should be registered or an authentication requires status in which an authentication process based on the unique information of the equipment concerned should be executed, a registration unit registering, when the status judging unit judges that the operation status is the registration required status, the unique information of the equipment concerned in the fourth storage unit, a fourth authentication unit judging, when the status judging unit judges that the operation status is the authentication required status, whether the unique information of the equipment concerned is coincident with any one of pieces of the unique information stored in the fourth storage unit, and a switchover unit setting, when the fourth authentication unit judges that the unique information is coincident with the other piece of unique information, the equipment concerned in a network communication-enabled status.

With this configuration, when receiving the identification information and the password information of the user and the unique information (of the equipment) from the equipment requesting the network connection, if in the registration-required status, irrespective of whether the unique information of the equipment concerned is registered or not, the authentication is performed by using the identification information and the password information of the user of this equipment, and, when succeeding in this authentication, the unique information of the equipment is registered. Further, also if in the authentication-required status, irrespective of whether the unique information of the equipment concerned is registered or not, the authentication is performed by using the identification information and the password information of the user of this equipment, however, unless succeeding in the authentication using the unique information of the equipment, this equipment is not authorized to connect with the network. Hence, according to the second mode also, there is no necessity of being burdened with reading the unique information from the equipment and manually registering the unique information and of taking a means for separately preparing the device for collecting the unique information. Besides, in the registration-requires status, the authentication is invariably conducted by use of the tuple of the identification information and the password information of the user. On the other hand, in the authentication-required status, the authentication is invariably conducted by employing all of the tuple of the identification information and the password information of the user and the unique information, and therefore it never happens that the unique information of the equipment that should not be authorized to connect with the network is mistakenly registered.

As discussed above, according to the present invention, the registration operation is facilitated while assuring that only equipment authorized to establish the network connection is registered.

### BRIEF DESCRIPTION OF SEVERAL VIEWS OF THE DRAWINGS

FIG. 1 is a diagram showing architecture of a computer network system according to a first embodiment;

FIG. 2 is a diagram showing one example of a data structure of an authentication information table;

FIG. 3 is a flowchart showing a flow of an equipment authentication process;

FIG. 4 is a flowchart showing a flow of the equipment authentication process according to a second embodiment; and

FIG. 5 is a flowchart showing a flow of the equipment authentication process according to a third embodiment.

### DETAILED DESCRIPTION OF THE PREFERRED EMBODIMENTS

Next, three best modes (embodiments) for carrying out the present invention will hereinafter be described in detail with reference to the accompanying drawings.

### First Embodiment

To begin with, architecture of a computer network system according to a first embodiment will be explained.

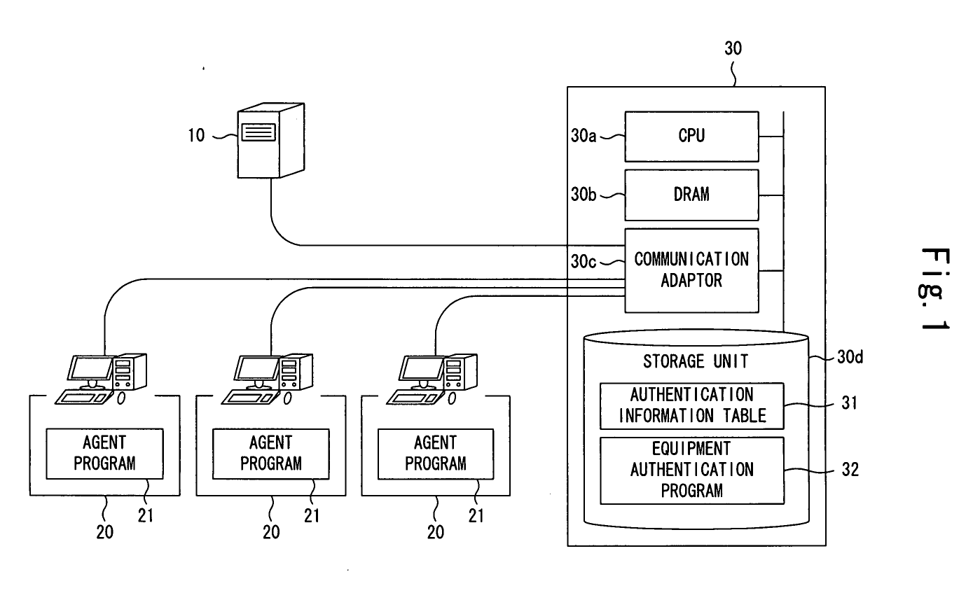

FIG. 1 is a diagram showing the architecture of the computer network system according to the first embodiment.

As illustrated in FIG. 1, the computer network system according to the first embodiment is configured by a Web server device 10, one or more Web client devices 20 and an authentication switch device 30. The Web server device 10 and the Web client devices 20 are connected to each other via the authentication switch device 30.

The Web server device 10, when accepting a request from the Web client device 20, sends data corresponding to this request. A configuration of the Web server device 10 will be briefly described. The Web server device 10 is constructed by installing a Web server program into a well-known computer which incorporates pieces of hardware such as a CPU (Central Processing unit), a DRAM (Dynamic Random Access Memory), a storage unit and a communication adaptor.

On the other hand, the Web client device 20 requests the Web server device 10 for the data on the basis of an operator's instruction and, when the data is transmitted from the Web server device 10, displays a content based on this data. A configuration of the Web client device 20 will be briefly described. The Web client device 20 is constructed by installing a Web Browser program into a general type of personal computer of which a main body incorporates pieces hardware such as a CPU, a DRAM, an HDD (Hard Disk Drive), an MDD (Multi Disk Drive) and a communication adaptor.

Further, an agent program 21 is installed into the unillustrated HDD built in this Web client device 20. The agent program 21 is a program for sending an access request for accessing the Web server device 10 to the authentication switch device 30 that will be explained later on when receiving an execution instruction from the operator via an input device such as a keyboard and a mouse or when the execution instruction is given based on initial setting when started up. Moreover, the agent program 21 is also a program for transmitting, to the authentication switch device 30, a MAC (Media Access Control) address of the device 20 or user information and password information of the operator in response to the request from the authentication switch device 30 that will be mentioned later on. It is to be noted that the user information is identification information for individually (uniquely) identifying each user among the users of the respective Web client devices 20, and the password information is information needed for the user to be authorized for enabling the Web client device 20 of user's own to communicate with the Web server device 10.

The authentication switch device 30 has a function of relaying the data between the Web server device 10 and the Web client device 20 and a function of judging whether or not the Web client device 20 is a device authorized to access the Web server device 10. Herein, the former function (the data relay function) is that the data is relayed between, in a plurality of connection ports, only the port set in a communication-enabled status by the latter function (the authorization judging function) and the port to which the Web server device 10 is connected. Note that the former function of relaying the data between plural ports is universally known, and hence its explanation is omitted hereafter.

A configuration of the authentication switch device 30 will be described. The authentication switch device 30 has built-in components such as a CPU 30a, a DRAM 30b, a communication adaptor 30c and a storage unit 30d. Among these components, the communication adaptor 30c has, though not illustrated, a plurality of connection ports. The general type of personal computer can be connected to these respective connection ports via a cable such as a LAN (Local Area Network) cable.

Further, the storage unit 30d in this authentication switch device 30 is stored with an authentication information table 31 and an equipment authentication program 32.

In these software components, the authentication information table 31 is a table for recording pieces of information on the access-authorized equipment to the Web server device 10.

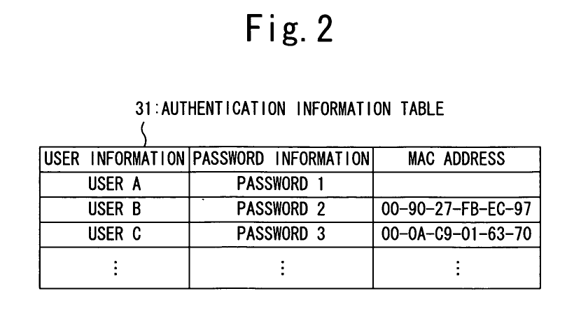

FIG. 2 is a diagram showing one example of a data structure of the authentication information table 31.

The authentication information table 31 in FIG. 2 has the same number of records as the number of users authorized by an administrator of the computer network system to access the Web server device 10. Each of the records has a [user information] field, a [password information] field and a [MAC address] field.

The [user information] field and the [password information] field are fields in which the user information and the password information of the user concerned are recorded (entered). The [MAC address] field is a field in which to record a MAC address assigned as unique information to the communication adaptor built in the user's device (the Web client device 20).

Herein, the user information and the password information are information of which the administrator of the computer network system previously notifies the user authorized to access the Web server device 10. The user information and the password information are also information to be registered by the administrator in the authentication information table 31 before starting the operation of the authentication switch device 30 after notifying the user. Further, the MAC address is information to be registered in the authentication information table 31 by a process that will be explained later on. Before starting the operation of the authentication switch device 30, the [MAC address] field in each of the records in this table 31 is null (no value).

It should be noted that the authentication information table 31 corresponds to the first and second storage units described above.

The equipment authentication program 32 is a program for judging whether or not the Web client device 20 is a device authorized to access the Web server device 10. A content of processes executed by the CPU 30a according to the equipment authentication program 32 will be described afterward.

Next, processes executed in the authentication switch device 30 will be explained.

To start with, when the operator of the Web client device 20 starts up the agent program 21 in the device 20 (when starting up the Web client device 20 in a case where the agent program 21 is so set as to be automatically executed after starting up the device 20), as described above, the agent function of the agent program 21 (which will herein after be termed the agent function 21) sends the access request for accessing the Web server device 10 to the authentication switch device 30.

Then, the CPU 30a of the authentication switch device 30 starts, as triggered by receiving this request, the equipment authentication process in a way that reads the equipment authentication program 32.

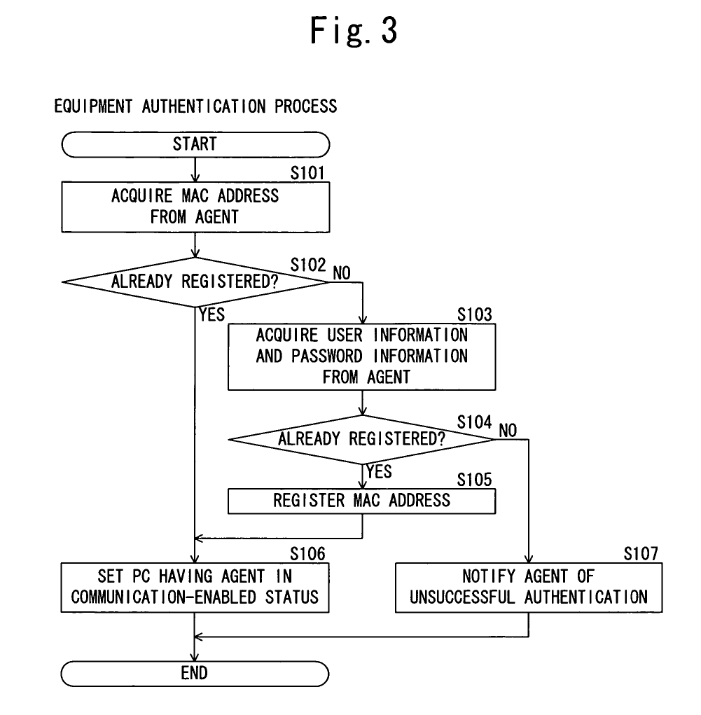

FIG. 3 is a flowchart showing a flow of the equipment authentication process.

After starting the equipment authentication process, in first step S101, the CPU 30a requests the agent function 21 as a requester to send the MAC address of the Web client device 20 on which the agent function (agent program) runs. Then, the CPU 30a acquires the MAC address by receiving the MAC address from the agent function 21 as a response to this request.

Subsequently, in next step S102, the CPU 30a judges whether or not a MAC address identical with the MAC address acquired in step S101 has already been registered in the authentication information table 31 in FIG. 2.

It is to be noted that the CPU 30a executing step S101 and step S102 corresponds to the first authentication unit described above.

Then, the CPU 30a, when judging that the MAC address identical with the MAC address acquired in step S101 has already been registered in the authentication information table 31 in FIG. 2, proceeds with the processing from step S102 to step S106.

In step S106, the CPU 30a sets a communication-enabled status (a data relay function running status) between the port connected to the Web client device 20 on which the agent function 21 runs and the port connected to the Web server device 10. Thereafter, the CPU 30a terminates the equipment authentication process shown in FIG. 3.

It should be noted that the CPU 30a executing this step S106 corresponds to the switchover unit described above. While on the other hand, the CPU 30a, when judging that the MAC address identical with the MAC address acquired in step S101 is not yet registered in the authentication information table 31 in FIG. 2, diverts the processing from step S102 to step S103.

In step S103, the CPU 30a requests the agent function 21 to send the user information and the password information of the user of the Web client device 20 on which the agent function runs. Then, the CPU 30a acquires the user information and the password information in a way that receives the user information and the password information from the agent function 21 as a response to this request. Note that the agent function 21 maybe a function of acquiring the user information and the password information from the user by displaying an input screen on a display device such as a liquid crystal display each time the request is given from the authentication switch device 30, and may also be a function of previously retaining the user information and the password information on an internal system, which have been accepted from the user, and reading these items of information from the internal system each time the request is given from the authentication switch device 30.

Subsequently, in next step S104, the CPU 30a,judges whether or not the record containing a tuple of the user information and the password information acquired in step S103 has already been registered in the authentication information table 31 in FIG. 2.

It should be noted that the CPU 30a executing step S104 corresponds to the second authentication unit described above.

Then, the CPU 30a, when judging that the record containing the tuple of the user information and the password information acquired in step S103 has already been registered in the authentication information table 31 in FIG. 2, proceeds with the processing from step S104 to step S105.

In step S105, the CPU 30a registers the MAC address acquired in step S101 by entering this MAC address in the [MAC address] field of the record in the authentication information table 31 in FIG. 2.

It is to be noted that the CPU 30a executing step S105 corresponds to the registration unit described above.

In subsequent step S106, the CPU 30a, as stated above, sets the communication-enabled status between the port connected to the Web client device 20 on which the agent function 21 runs and the port connected to the Web server device 10.

While on the other hand, the CPU 30a, when judging that the record containing the tuple of the user information and the password information acquired in step S103 is not yet registered in the authentication information table 31 in FIG. 2, diverts the processing from step S104 to step S107.

In step S107, the CPU 30a, in a way that keeps a communication-disabled status (a data relay function disabled status) between the port connected to the Web client device 20 on which the agent function 21 runs and the port connected to the Web server device 10, notifies the requester agent function 21 of the purport that the authentication gets unsuccessful. Thereafter, the CPU 30a terminates the equipment authentication process shown in FIG. 3. Note that the agent function 21, it is desirable, be a function of executing an output process such as displaying, when receiving this notification, the purport thereof on the display device.

Next, an operation and an effect of the authentication switch device 30 according to the first embodiment will be explained.

The user of the Web client device 20 connects the Web client device 20 to the authentication switch device 30, thereby running the agent function 21. Thereupon, the equipment is authenticated by use of the MAC address of the Web client device 20 (step S102). Then, if this MAC address has already been registered in the authentication switch device 30, the Web client device 20 gets into the communication-enabled status with the Web server device 10 (step S102; YES, S106).

Further, if the user connects the user's Web client device 20 to the Web server device 10 for the first time, since the MAC address is not yet registered in the authentication switch device 30, the equipment authentication using the MAC address becomes unsuccessful (step S102; NO). In this case, the equipment authentication is conducted based on the tuple of the user information and the password information of the user (step S104). If this second authentication gets successful, the MAC address of the user's Web client device 20 is registered in the authentication switch device 30, and the Web client device 20 is set in the communication-enabled status with the Web server device 10 through the authentication switch device 30 (step S104; YES, S105, S106). Then, if this user connects the user's Web client device 20 to the Web server device 10 from the next time onward, since the MAC address of this Web client device 20 has already been registered in the authentication switch device 30, it follows that the access to the Web server device 10 can be done simply by the equipment authentication using the MAC address.

Further, if an unauthorized user tries to connect the Web client device 20 of the unauthorized user to the Web server device 10, a MAC address of this Web client device 20 is not registered in the authentication switch device 30, and besides user information and password information of the unauthorized user are not registered therein, and hence it never happens that the information is leaked out of the Web server device 10 and an unauthorized connection to the Web server device 10 is made by the unauthorized user.

Thus, the authentication switch device 30 according to the first embodiment burdens neither the user with reading the MAC address from the user's Web client device 20 nor the administrator of the computer network system with manually registering the readout MAC address in the authentication switch device 30. Further, there is no necessity of separately preparing a device for collecting the respective MAC addresses of the Web client devices 20 connected to the authentication switch device 30. Moreover, the equipment authentication is invariably conducted by use either of the MAC address or the tuple of the user information and the password information of the user, and hence it never happens that the authentication switch device 30 is mistakenly registered with the MAC address of the Web client device 20 that should not be authorized to establish the network connection.

It should be noted that the main device for authenticating the equipment is the authentication switch device 30 in the first embodiment discussed above but is not limited to the authentication switch device 30 and may also be, for example, a firewall device. If the firewall device authenticates the equipment (the processes in FIG. 3) in the first embodiment, it follows not that permission or non-permission of the data relay between the connection ports is controlled but that the permission or non-permission of the data relay between IP (Internet Protocol) addresses is controlled.

### Second Embodiment

A second embodiment is different, in terms of using a combination of the MAC address, the user information and the password information, from the first embodiment for conducting the equipment authentication by use of the MAC address as the single authentication information. Configurations other than this different point, such as the network architecture in FIG. 1, the internal structures of the respective devices 10 through 30 and the contents of the authentication information table 31 in FIG. 2, are the same as those in the first embodiment. An equipment authentication process in the second embodiment will hereinafter be described.

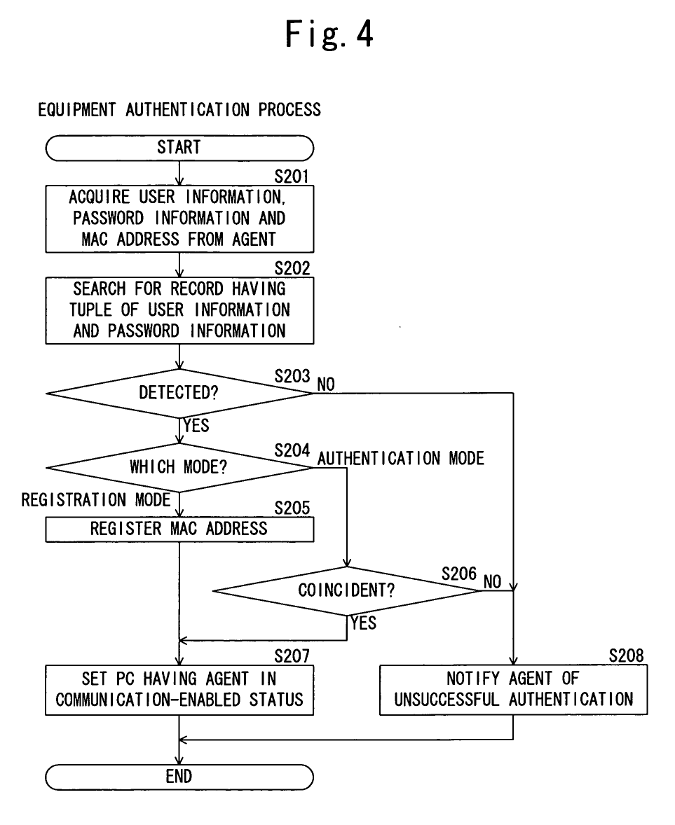

FIG. 4 is a flowchart showing a flow of the equipment authentication process according to the second embodiment.

After starting the equipment authentication process, in first step S201, the CPU 30a requests the agent function 21 as a requester to send the user information and the password information of the user and the MAC address of the Web client device 20 on which the agent function runs. Then, the CPU 30a acquires the user information, the password information and the MAC address by receiving the user information, the password information and the MAC address from the agent function 21 as a response to this request.

Subsequently, in next step S202, the CPU 30a executes a process of searching for a record having a tuple of the user information and the password information acquired in step S201 in the records within the authentication information table 31 in FIG. 2.

Then, in next step S203, the CPU 30a judges whether or not the record having the tuple of the user information and the password information acquired in step S201 can be detected from the authentication information table 31 in FIG. 2.

It is to be noted that the CPU 30a executing steps S201 through S203 corresponds to the third authentication unit described above.

Then, the CPU 30a, when judging that the record having the tuple of the user information and the password information acquired in step S201 cannot be detected from the authentication information table 31 in FIG. 2, diverts the processing from step S203 to step S208.

In step S208, the CPU 30a, in a way that keeps a communication-disabled status (a data relay function disabled status) between the port connected to the Web client device 20 on which the agent function 21 runs and the port connected to the Web server device 10, notifies the requester agent function 21 of the purport that the authentication gets unsuccessful. Thereafter, the CPU 30a terminates the equipment authentication process shown in FIG. 4.

While on the other hand, the CPU 30a, when judging that the record having the tuple of the user information and the password information acquired in step S201 can be detected from the authentication information table 31 in FIG. 2, proceeds with the processing from step S203 to step S204.

In step S204, the CPU 30a judges whether an operation mode of the authentication switch device 30 is set to a registration mode or an authentication mode.

Herein the authentication mode is an operation mode in which the equipment authentication is performed by using the combination of the user information, the password information and the MAC address. On the other hand, the registration mode is an operation mode in which the equipment authentication is conducted by employing only the tuple of the user information and the password information. The authentication mode is the operation mode that is normally employed, while the registration mode is the operation mode set by the administrator of the computer network system when registering the MAC address in the authentication switch device 30 for a fixed period of time after building up the computer network system. As explained later on, during the authentication mode, there is not accepted an access to the Web server device 10 from the Web client device 20 of which the MAC address is not registered within a period for which the registration mode is set.

Accordingly, the CPU 30a executing this step S204 corresponds to the status judging unit described above.

Then, the CPU 30a, when judging that the operation mode of the authentication switch device 30 is set to the registration mode, proceeds with the processing from step S204 to step S205.

In step S205, the CPU 30a registers the MAC address acquired in step S201 by entering this MAC address in the [MAC address] field of the record in the authentication information table 31 in FIG. 2, which has been detected in step S202.

It is to be noted that the CPU 30a executing step S205 corresponds to the registration unit described above.

Thereafter, in step S207, the CPU 30a sets a communication-enabled status between the port connected to the Web client device 20 on which the agent function 21 runs and the port connected to the Web server device 10, and terminates the equipment authentication process shown in FIG. 4.

It should be noted that the CPU 30a executing this step S207 corresponds to the switchover unit described above.

While on the other hand, the CPU 30a, when judging that the operation mode of the authentication switch device 30 is set to the authentication mode, diverts the processing from step S204 to step S206.

In step S206, the CPU 30a judges whether or not the MAC address acquired in step S201 is coincident with a value entered in the [MAC address] field of the record detected in step S202.

It should be noted that the CPU 30a executing step S206 corresponds to the fourth authentication unit described above.

Then, the CPU 30a, when judging that the MAC address acquired in step S201 is coincident with the value entered in the [MAC address] field of the record detected in step S202, proceeds with the processing from step S206 to step S207.

In step S207, the CPU 30a, as described above, sets the communication-enabled status between the port connected to the Web client device 20 on which the agent function 21 runs and the port connected to the Web server device 10, and terminates the equipment authentication process shown in FIG. 4.

While on the other hand, the CPU 30a, when judging that the MAC address acquired in step S201 is not coincident with the value entered in the [MAC address] field of the record detected in step S202, diverts the processing from step S206 to step S208.

In step S208, the CPU 30a, as explained above, in a way that keeps a communication-disabled status (a data relay function disabled status) between the port connected to the Web client device 20 on which the agent function 21 runs and the port connected to the Web server device 10, notifies the requester agent function 21 of the purport that the authentication gets unsuccessful. Thereafter, the CPU 30a, terminates the equipment authentication process shown in FIG. 4.

Next, an operation and an effect of the authentication switch device 30 according to the second embodiment will be explained.

At first, the administrator of the computer network system sets the operation mode of the authentication switch device 30 to the registration mode, in which case when the user of the Web client device 20 connects the Web client device 20 to the authentication switch device 30 and runs the agent function 21, the equipment is authenticated by use of the tuple of the user information and the password information of the user of the Web client device 20 (steps S202, S203) Thereafter, the MAC address is registered in the authentication switch device 30, whereby the Web client device 20 gets into the communication-enabled status with the Web server device 10 (step S204; registration mode, S205, S207).

Next, the administrator of the computer network system sets the operation mode of the authentication switch device 30 to the authentication mode, in which case when the user of the Web client device 20 connects the Web client device 20 to the authentication switch device 30 and runs the agent function 21, in the same way as in the registration mode, the equipment is authenticated by use of the tuple of the user information and the password information of the user of the Web client device 20 (steps S202, S203) Thereafter, however, unlike the registration mode, the equipment authentication using the MAC address is further conducted (step S204; authentication mode, S206). Then, if succeeding in this equipment authentication, the Web client device 20 becomes the communication-enabled status with the Web server device 10 (step S206; YES, S207). Whereas if this equipment authentication gets into a failure, even when the authentication becomes successful by employing the tuple of the user information and the password information, this Web client device 20 is unable to access the Web server device 10 (step S206; No, S208).

Further, if the unauthorized user tries to connect the Web client device 20 of the unauthorized user to the Web server device 10, the user information and the password information this unauthorized user are not registered in the authentication switch device 30, and hence, whichever operation mode the authentication switch device 30 is set in, the Web client device 20 of the unauthorized user is not authenticated. Accordingly, it never happens that the information is leaked out of the Web server device 10 and an unauthorized connection to the Web server device 10 is made by the unauthorized user.

Thus, the authentication switch device 30 according to the second embodiment also burdens neither the user with reading the MAC address from the user's Web client device 20 nor the administrator of the computer network system with manually registering the readout MAC address in the authentication switch device 30. Further, there is no necessity of separately preparing a device for collecting the respective MAC addresses of the Web client devices 20 connected to the authentication switch device 30. Moreover, in the registration mode, the equipment authentication is invariably conducted by use of the tuple of the user information and the password information of the user and is likewise conducted, in the authentication mode, by the combination of the user information, the password information and the MAC address, and hence it never happens that the authentication switch device 30 is mistakenly registered with the MAC address of the Web client device 20 that should not be authorized to establish the network connection.

### Third Embodiment

A third embodiment is different, in terms of judging which operation should be done, the registration of the MAC address or the equipment authentication, each time the Web client device 20 makes the access request, from the second embodiment for executing any one of the registration of the MAC address and the equipment authentication for every Web client device 20 according to the operation mode of the authentication switch device 30. Configurations other than this different point, such as the network architecture in FIG. 1, the internal structures of the respective devices 10 through 30 and the contents of the authentication information table 31 in FIG. 2, are the same as those in the first and second embodiments. An equipment authentication process in the third embodiment will hereinafter be described.

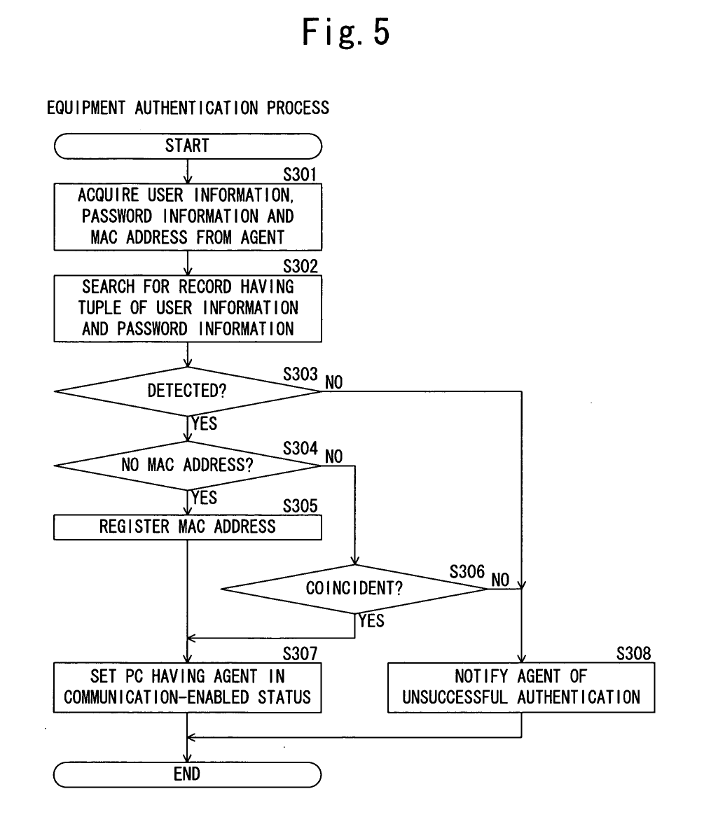

FIG. 5 is a flowchart showing a flow of the equipment authentication process according to the third embodiment.

As obvious from a comparison between FIGS. 5 and 4, the equipment authentication process in the third embodiment is almost the same as in the second embodiment, however, step S304 is different from step S204 in the second embodiment.

As discussed above, in step S204 in the second embodiment, the CPU 30a judges whether the operation mode of the authentication switch device 30 is set to the registration mode or the authentication mode.

By contrast, in step S304 in the third embodiment, the CPU 30a judges whether or not a value is entered in the [MAC address] field of the record detected in step S302.

Then, the CPU 30a, when judging that the value is not entered in the [MAC address] field of the record detected in step S302, proceeds with the processing from step S304 to step S305. In step S305, the CPU 30a executes a process of registering the MAC address acquired in step S301.

While on the other hand, the CPU 30a, when judging that the value is entered in the [MAC address] field of the record detected in step S302, judges whether or not the value in the [MAC address] field is coincident with the MAC address acquired in step S301.

Then, the CPU 30a, when judging that the value in the [MAC address] field of the record detected in step S302 is coincident with the MAC address acquired in step S301, moves the processing from step S306 to step S307, wherein the CPU 30a sets the Web client device 20 in the communication-enabled status with the Web server device 10.

Conversely, the CPU 30a, when judging that the value in the [MAC address] field of the record detected in step S302 is not coincident with the MAC address acquired in step S301, moves the processing from step S306 to step S308, wherein the CPU 30a, in a way that keeps a communication-disabled status (a data relay function disabled status) between the port connected to the Web client device 20 on which the agent function 21 runs and the port connected to the Web server device 10, notifies the requester agent function 21 of the purport that the authentication gets unsuccessful.

It should be noted that the CPU 30a executing step S304 corresponds to the status judging unit described above.

If the equipment authentication process is configured as in the third embodiment (as shown in FIG. 5), each time the Web client device 20 of the user having the valid user information and password information makes the access request, it is judged which operation, the registration of the MAC address or the equipment authentication, should be done. Therefore, the administrator of the computer network system may not have the necessity of setting the operation mode of the authentication switch device 30 every time as in the case of the second embodiment.

What is claimed is:

1. An equipment authentication device comprising:
a first storage unit storing unique information of equipment with respect to some equipment in pieces of equipment authorized to establish a connection to a network;
a second storage unit storing identification information and password information of a user of the equipment with respect to the respective pieces of equipment;
a first authentication unit judging, when accepting a network connection request together with the unique information of the equipment from any one of pieces of the equipment via a communication device, whether or not the unique information is coincident with any one of pieces of unique information stored in said first storage unit;
a switchover unit setting, when said first authentication unit judges that the unique information is coincident with the other piece of unique information, the equipment concerned in a network communication-enabled status;
a second authentication unit acquiring, when said first authentication unit judges that the unique information is not coincident with the other piece of unique information, the identification information and the password information of the user from the equipment concerned, and judging whether or not a tuple of the identification information and the password information is coincident with a tuple of the identification information and the password information stored in said second storage unit; and
a registration unit registering, when said second authentication unit judges that the tuples of the identification information and the password information are coincident with each other, the unique information of the equipment concerned in said first storage unit.

2. An equipment authentication device according to claim 1, wherein said switchover unit sets the equipment in the network communication-enabled status also after said registration unit has registered the unique information in said first storage unit.

3. An equipment authentication device comprising:
a third storage unit storing identification information and password information of user of equipment with respect to each piece of equipment authorized to establish a connection to a network;
a fourth storage unit storing unique information of the equipment with respect to some pieces of equipment in the pieces of equipment;
a third authentication unit judging, when accepting a network connection request together with identification information and password information of a user of the equipment and the unique information of the equipment from any one of pieces of the equipment via a communication device, whether or not a tuple of the identification information and the password information is coincident with a tuple of the identification information and the password information stored in said third storage unit;
a status judging unit judging, when said third authentication unit judges that the tuples of the identification information and the password information are coincident with each other, whether an operation status is a registration required status in which the unique information of the equipment concerned should be registered or an authentication requires status in which an authentication process based on the unique information of the equipment concerned should be executed;
a registration unit registering, when said status judging unit judges that the operation status is the registration required status, the unique information of the equipment concerned in said fourth storage unit;
a fourth authentication unit judging, when said status judging unit judges that the operation status is the authentication required status, whether the unique information of the equipment concerned is coincident with any one of pieces of the unique information stored in said fourth storage unit; and
a switchover unit setting, when said fourth authentication unit judges that the unique information is coincident with the other piece of unique information, the equipment concerned in a network communication-enabled status.

4. An equipment authentication device according to claim 3, wherein said status judging unit judges which mode, a registration mode or an authentication mode, the operation mode is set to,
said registration unit registers, when said status judging unit judges that the operation mode is the registration mode, unique information of the equipment concerned in said fourth storage unit, and
said fourth authentication unit judges, when said status judging unit judges that the operation mode is the authentication mode, whether or not the unique information of the equipment concerned is coincident with any one of pieces of unique information stored in said fourth storage unit.

5. An equipment authentication device according to claim 3, wherein said status judging unit judges whether or not the unique information of the equipment concerned has already been registered in said fourth storage unit,
said registration unit registers, when said status judging unit judges that the unique information of the equipment concerned is not yet registered in said fourth storage unit, the unique information of the equipment concerned in said fourth storage unit, and
said fourth authentication unit judges, when said status judging unit judges that the unique information of the equipment concerned has already been registered in said fourth storage unit, whether or not the unique information of the equipment concerned is coincident with any one of pieces of unique information stored in said fourth storage unit.

6. An equipment authentication program making a computer function as:
first storage means storing a storage device with unique information of equipment with respect to some equipment in pieces of equipment authorized to establish a connection to a network;
second storage means storing said storage device with identification information and password information of a user of the equipment with respect to the respective pieces of equipment;
first authentication means judging, when accepting a network connection request together with the unique information of the equipment from any one of piece of the equipment via a communication device, whether or not the unique information is coincident with any one of pieces of unique information stored in said storage device;
switchover means setting, when said first authentication means judges that the unique information is coincident with the other piece of unique information, the equipment concerned in a network communication-enabled status;
second authentication means acquiring, when said first authentication means judges that the unique information is not coincident with the other piece of unique information, the identification information and the password information of the user from the equipment concerned, and judging whether or not a tuple of the identification information and the password information is coincident with a tuple of the identification information and the password information stored in said storage device; and
registration means making, when said second authentication means judges that the tuples of the identification information and the password information are coincident with each other, said first storage means register the unique information of the equipment concerned in said storage device.

7. An equipment authentication program making a computer function as:
third storage means storing a storage device with identification information and password information of user of equipment with respect to each piece of equipment authorized to establish a connection to a network;
fourth storage means storing said storage device with unique information of the equipment with respect to some pieces of equipment in the pieces of equipment;
third authentication means judging, when accepting a network connection request together with identification information and password information of a user of the equipment and the unique information of the equipment from any one of pieces of the equipment via a communication device, whether or not a tuple of the identification information and the password information is coincident with a tuple of the identification information and the password information stored in said storage device;
status judging means judging, when said third authentication means judges that the tuples of the identification information and the password information are coincident with each other, whether an operation status is a registration required status in which the unique information of the equipment concerned should be registered or an authentication requires status in which an authentication process based on the unique information of the equipment concerned should be executed;
registration means making, when said status judging means judges that the operation status is the registration required status, said fourth storage means register the unique information of the equipment concerned in said storage device;
fourth authentication means judging, when said status judging means judges that the operation status is the authentication required status, whether the unique information of the equipment concerned is coincident with any one of pieces of the unique information stored in said storage device; and
switchover means setting, when said fourth authentication means judges that the unique information is coincident with the other piece of unique information, the equipment concerned in a network communication-enabled status.
